(19) United States
(12) Patent Application Publication
(10) Pub. No.: US 2025/0285779 A1
(43) Pub. Date: Sep. 11, 2025

(54) DEVICE FOR TRAPPING ONE OR MORE PARTICLES AND ASSOCIATED METHOD AND SYSTEM

(71) Applicant: Infineon Technologies Austria AG, Villach (AT)

(72) Inventors: Klemens Karl Heinrich Schüppert, Goritschach (AT); Matthias Brandl, Kirchseeon (DE)

(21) Appl. No.: 19/072,262

(22) Filed: Mar. 6, 2025

(30) Foreign Application Priority Data
Mar. 8, 2024 (EP) 24162244
Feb. 25, 2025 (DE) 102025106974.3

(51) Int. Cl. G21K 1/00

(52) U.S. Cl. CPC G21K 1/00

(57) ABSTRACT

A device for trapping one or more particles includes first and second RF electrodes and DC electrodes. The first and second RF electrodes extend in a first direction and both have opposite first and second sides, with the first sides facing towards one another. In a center region of the first and second RF electrodes, the first sides have a first distance with respect to each other. Also in the center region, the second sides have a second distance with respect to each other. In an ending region of the first and second RF electrodes: the first sides have a distance that is greater than the first distance; and/or the second sides have a distance that is less than the second distance.

### BACKGROUND

Trapped particles (such as electrons, ions or molecules) are a promising candidate for use as qubits (quantum bits) in quantum computers. Moreover, trapped particles (such as electrons, ions or molecules) can be used in metrology (e.g., in atomic clocks).

Felix Stopp et al (2021) arXiv:2108.06948v1 [quant-ph] discloses that an ion trap is used where ions are extracted and sent to free space. The ion trajectories are reflected and the ions are captured entering from free space in the ion trap where they started. Both, in order to send the ions to free space and in order to capture the ions from free space, the radio frequency (RF) signal of the ion trap is ramped (e.g., by increasing/decreasing the amplitude of the applied RF voltage over a given period of time).

In practical applications, the exact tuning of the ramping of the RF signal may be challenging. Therefore, it may be desirable to provide an improved trapping device that may allow sending one or more particles (such as ions) away from the trapping device and/or receiving one or more particles (such as ions). It may also be desirable to provide a system and a method that may use at least some of the above-described principles.

### SUMMARY

According to embodiments, a device for trapping one or more particles comprises a first radio-frequency (RF) electrode, a second RF electrode, and a plurality of direct current (DC) electrodes. The first RF electrode and the second RF electrode may extend in a first direction. The first RF electrode may comprise a first side and a second side. The second side of the first RF electrode may be arranged opposite to the first side of the first RF electrode. The second RF electrode may comprise a first side and a second side. The second side of the second RF electrodes may be arranged opposite the first side of the second RF electrode. The first side of the first RF electrode may face towards the first side of the second RF electrode. In a center region of the first RF electrode and the second RF electrode, the first side of the first RF electrode and the first side of the second RF electrode may have a first distance d_{1,c} with respect to each other. In the center region of the first RF electrode and the second RF electrode, the second side of the first RF electrode and the second side of the second RF electrode may have a second distance d_{2,c} with respect to each other. In an ending region of the first RF electrode and the second RF electrode: the first side of the first RF electrode and the first side of the second RF electrode have a distance d₁ that is greater than the first distance d_{1,c}; and/or the second side of the first RF electrode and the second side of the second RF electrode have a distance de that is less than the second distance d_{2,c}.

According to embodiments, a system comprises a first device for trapping one or more particles, and a second device for trapping one or more particles. The first device may be configured to trap at least one particle provided by a particle source. The second device may be configured to receive the at least one particle from the first device, and to perform one or more quantum gate operations on the at least one particle.

According to embodiments, a method of providing one or more particles to a device for trapping one or more particles, the method comprises trapping, by a first device, at least one particle provided by a particle source. The method may further comprise providing, by the first device, the at least one particle to a second device. The method may further comprise receiving, by the second device, the at least one particle. The method may further comprise performing, by the second device, one or more quantum gate operations on the at least one particle. Those skilled in the art will recognize additional features and advantages upon reading the following detailed description, and upon viewing the accompanying drawings.

### BRIEF DESCRIPTION OF THE DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other and/or can be selectively omitted if not described to be necessarily required.

FIG. 1A illustrates a top view of a device for trapping one or more particles (such as ions) according to an example of the present disclosure.

FIG. 1B illustrates a top view of a device for trapping one or more particles (such as ions) according to another example of the present disclosure.

FIG. 1C illustrates a top view of a device for trapping one or more particles (such as ions) according to yet another example of the present disclosure.

FIG. 2A illustrates a cross sectional view of a device for trapping one or more particles (such as ions) according to an example of the present disclosure.

FIG. 2B illustrates a cross sectional view of a device for trapping one or more particles (such as ions) according to an example of the present disclosure.

FIG. 2C illustrates a cross sectional view of a device for trapping one or more particles (such as ions) according to another example of the present disclosure.

FIG. 3 illustrates a top view of a device for trapping one or more particles (such as ions) according to an example of the present disclosure.

FIG. 4 illustrates a top view of a device for trapping one or more particles (such as ions) according to an example of the present disclosure.

FIG. 5 illustrates a top view of a device for trapping one or more particles (such as ions) according to an example of the present disclosure.

FIG. 6 illustrates a top view of a device for trapping one or more particles (such as ions) according to an example of the present disclosure.

FIG. 7 illustrates a top view of a device for trapping one or more particles (such as ions) according to an example of the present disclosure.

FIG. 8 illustrates a system including a first device for trapping one or more particles (such as ions) and a second device for trapping one or more particles according to an example of the present disclosure.

FIG. 9 illustrates a method for providing one or more particles (such as ions) to a device for trapping one or more particles.

Further examples are explained below with reference to the drawings. The drawings serve to illustrate certain principles, so that only aspects necessary for understanding these principles are illustrated in the drawings. Additional elements serving different functionality may be present in the illustrated devices, methods and systems, but may not be illustrated in the drawings.

### DETAILED DESCRIPTION

The devices described herein may be configured to trap one or more particles (such as ions, molecules or electrons) and control the trapped particles. In particular, the trapped particles may be physically grouped in particle chains (or strings or crystals). A particle chain may include one or multiple particles of the same or different species, wherein each of the particles (e.g., ions) may represent a physical qubit. In some examples, the devices described herein may be used for quantum computing, but are not restricted thereto. Trapped ions are one of the most promising candidates for being used as qubits in quantum computers, since they can be trapped with long lifetimes in a scalable array by means of electromagnetic fields. Other applications may be in the field of atomic clocks.

The trapped particles may be shuttled (or transported) along shuttling paths of the device. The shuttling paths may include straight sequences, but also junctions, such as X- junctions and/or T-junctions. For example, the shuttling paths may extend above multiple electrodes of the trapping device. Time-dependent electric fields may be used for shuttling the particles along the shuttling paths. A shuttling of the particles may be controlled by electric voltages applied to the electrodes of the device. In particular, the particles may be moved along shuttling paths by means of alternating current (AC) and direct current (DC) voltages that may be separately coupled to specific electrodes of the device. For example, the electrodes may include one or more radio-frequency (RF) electrodes for RF trapping and a plurality of DC electrodes for static electric-field trapping and/or for moving the particles within the trapping device. Trapping devices as described herein may be configured to trap a plurality of particles that may be individually addressable and movable by appropriately controlling the electric voltages of the electrodes.

In a specific but non-limiting example, the trapping devices described herein may correspond to or may include a surface trapping device (such as a Paul-trap) where all electrodes (i.e. the DC electrodes and the RF electrodes) may be arranged in a same single plane (e.g., in a structured electrode layer arranged on a substrate). The particles may be trapped and shuttled above this single plane. However, it is to be understood that the concepts described herein are not restricted to surface trapping devices. In further examples, devices for controlling trapped particles in accordance with the disclosure may also be based on three-dimensional (3D) trap geometries.

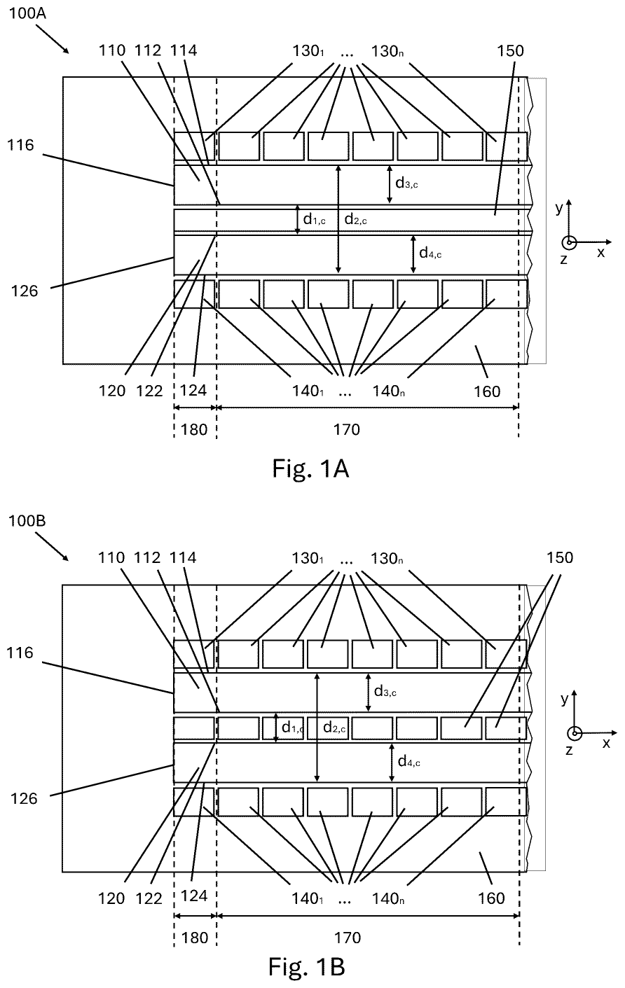

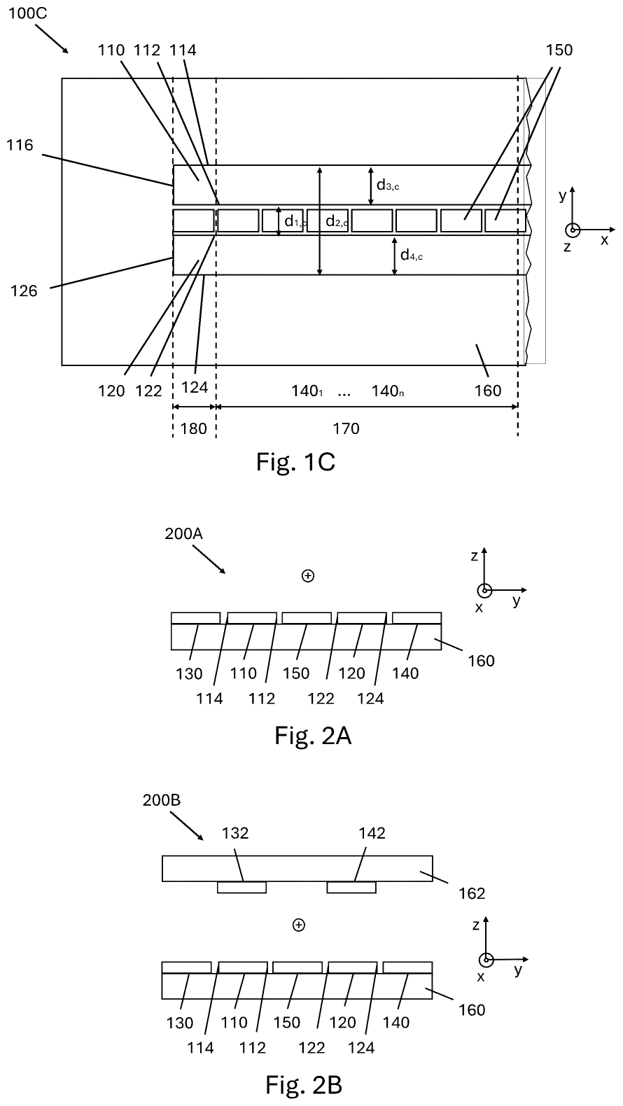

FIGS. 1A-1C illustrate typical layouts of a device 100A, 100B, 100C for trapping one or more particles. The drawings serve to illustrate certain principles, so that only aspects necessary for understanding these principles are illustrated. For example, the devices 100A, 100B, 100C may include additional DC electrodes, e.g., for compensating straight fields (e.g., connected to a ground potential or to another compensation potential) and/or for shielding that are not illustrated in the drawings.

The device 100A, 100B, 100C comprises a first radio-frequency (RF) electrode 110, a second RF electrode 120, and a plurality of direct current (DC) electrodes 130₁, . . . , 130ₙ, 140₁, . . . , 140ₙ, 150. These electrodes may be arranged above a substrate 160.

The first RF electrode 110 may extend in a first direction x and may comprise a first

side 112, a second side 114, and a first end 116. The first RF electrode 110 may further comprise a second end further downwards in the x-direction which is not shown in FIGS. 1A-1C. The first side 112 and the second side 114 of the first RF electrode 110 are spaced apart from each other along a second direction y (which may be orthogonal to the first direction x). The second side 114 of the first RF electrode 110 is arranged opposite to the first side 112 of the first RF electrode 110. Typically, the first end 116 and also the second end of the first RF electrode has a straight shape and is arranged with a 90° angle with respect to the first side 112 and the second side 114 of the first RF electrode 110.

The first direction x and the second direction y may be parallel to a first major surface of substrate 160 and may be referred to as lateral directions. Typically, particles may be trapped in a region that is distanced from the first RF electrode 110 and the second RF electrode 120 in a third direction z (which may be orthogonal to the first direction x and the second direction y). The third direction may be orthogonal to a first major surface of the substrate 160 and may be referred to as a vertical direction. The second RF electrode 120 may extend in the first direction x and may comprise a first side 122, a second side 124, and a first end 126. The second RF electrode 120 may further comprise a second end further downwards in the x-direction which is not shown in FIGS. 1A-1C. The first side 122 and the second side 124 of the second RF electrode 120 are spaced apart from each other along the second direction y. The second side 124 of the second RF electrode 120 is arranged opposite to the first side 122 of the second RF electrode 120. Typically, the first end 126 and also the second end of the second RF electrode 120 has a straight shape and is arranged with a 90° angle with respect to the first side 122 and the second side 124 of the second RF electrode 120.

In the device 100A, 100B, 100C as illustrated in FIGS. 1A-1C, the first side 112 of the first RF electrode 110 faces towards the first side 122 of the second RF electrode 120. In other words, the first side 112 of the first RF electrode and the first side 122 of the second electrode may be arranged closer to each other as compared to the second sides 114 and 124 of the first and second RF electrodes 110 and 120.

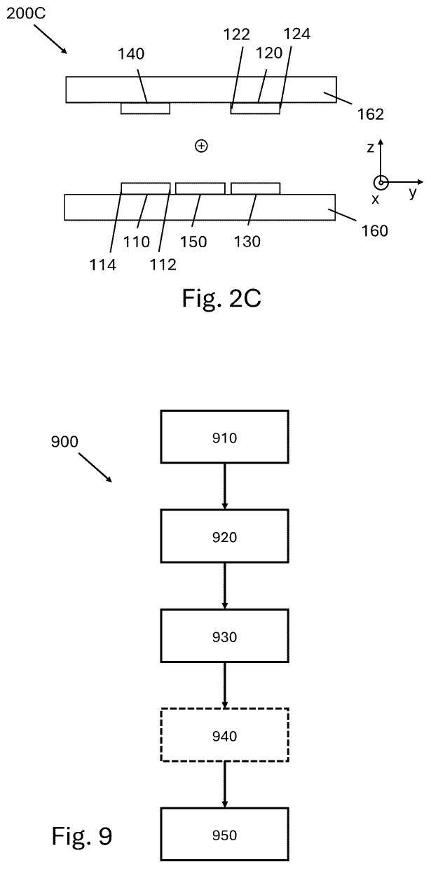

The device 100A, 100B, 100C comprises a center region 170 and an ending region 180 of the first RF electrode 110 and the second RF electrode 120. In the center region 170 of the first RF electrode 110 and the second RF electrode 120, the first side 112 of the first RF electrode 110 and the first side 122 of the second RF electrode 120 may have a first distance d_{1,c} with respect to each other. The first distance d_{1,c} may be measured along the second direction y (e.g., in case of a surface trapping device as illustrated with regard to FIG. 2A or with regard to a 3D trapping device as illustrated with regard to FIG. 2B). In other examples, the first distance d_{1,c} may be measured along a direction (which may be different from the second direction y) that lies in a plane formed by the second direction y and the third direction z (as illustrated with regard to FIG. 2C) and that is orthogonal to the first direction x.

In the center region 170 of the first RF electrode 110 and the second RF electrode 120, the second side 112 of the first RF electrode 110 and the second side 122 of the second RF electrode 120 have a second distance d_{2,c} with respect to each other. The second distance d_{2,c} may be measured along the second direction y (e.g., in case of a surface trapping device as illustrated with regard to FIG. 2A or with regard to a 3D trapping device as illustrated with regard to FIG. 2B). In other examples, the first distance d_{1,c} may be measured along a direction (which may be different from the second direction y) that lies in a plane formed by the second direction and the third direction (as illustrated with regard to FIG. 2C) and that is orthogonal to the first direction x. The second distance d_{2,c} is greater than the first distance d_{1,c}.

In the illustrated examples of FIGS. 1A-1C, the first distance d_{1,c} is substantially constant in the center region 170 and in the ending region 180 of the first RF electrode 110 and the second RF electrode 120. Similarly, the second distance d_{2,c} is substantially constant in the center region 170 and in the ending region 180 of the first RF electrode 110 and the second RF electrode 120. In the context of the present disclosure a value being substantially constant or two values being substantially the same shall mean that the value is constant or the two values are the same within typical processing variations. In an example, the first distance d_{1,c} may be in a range between 10 μm and 1000 μm, such as between 100 μm and 250 μm (such as 160 μm) and the second distance d_{2,c} may be in a range between, 50 μm and 5000 μm, such as between 500 μm and 750 μm (such as 660 μm). However, other values are possible and these exemplary values should not be construed limiting.

The first RF electrode 110 of device 100A, 100B, 100C may have a width that may be defined as a third distance d_{3,c.} between the first side 112 of the first RF electrode 110 and the second side 114 of the first RF electrode 110. The third distance d_{3,c.} may be measured along the second direction y. The second RF electrode 110 of device 100A, 100B, 100C may have a width that may be defined as a fourth distance d_{4,c.} between the first side 122 of the second RF electrode 120 and the second side 124 of the second RF electrode 110. The fourth distance d_{4,c.} may be measured along the second direction y. As illustrated with respect to FIGS. 1A-1C, device 100A, 100B, 100C the third distance d_{3,c} is substantially constant and the fourth distance d_{4,c} is substantially constant in the center region (170) and in the ending region 180 of the first RF electrode 110 and the second RF electrode 120. The third distance d_{3,c} and the fourth distance d_{4,c} may be measured along the second direction y.

In some examples the third distance d_{3,c} may be substantially equal to the fourth distance d_{4,c}. In other embodiments, the third distance d_{3,c} may differ from the fourth distance d_{4,c}. In an example, the third distance d_{3,c} may be in a range between 20 μm and 3 mm, such as between 100 μm and 750 μm (such as 250 μm) and the fourth distance d_{4,c} may be in a range between, 100 μm and 3 mm, such as between 100 μm and 750 μm (such as 250 μm). However, other values are possible and these exemplary values should not be construed limiting.

The first and second RF electrodes 110 and 120 of devices 100A, 100B, 100C as exemplarily illustrated in FIGS. 1A-1C are essentially the same. The devices 100A, 100B, and 100C only differ with respect to the arrangement of the DC electrodes 130₁, . . . , 130ₙ, 140₁, . . . , 140ₙ, 150. Generally, the DC electrodes 130₁, . . . , 130ₙ, 140₁, . . . , 140ₙ, 150 are arranged in proximity (such as adjacent) to the first RF electrode 110 and the second RF electrode 120. For example, the first RF electrode 110, the second RF electrode 120 and the DC electrodes 130₁, . . . , 130ₙ, 140₁, . . . , 140ₙ, 150 may be part of a (common) metallization structure (e.g., obtained by structuring one or more metallization layers) arranged on substrate 160.

As shown in FIGS. 1A-1C, the DC electrodes 130₁, . . . , 130ₙ, 140₁, . . . , 140ₙ, 150 may be arranged adjacent to the first RF electrode 110 and the second RF electrode 120 in the center region 170 and optionally also in the ending region 180.

Referring now to FIGS. 1A and 1B, the device 100A, 100B may have a first set 130₁, . . . , 130ₙ of the plurality of DC electrodes 130₁, . . . , 130ₙ, 140₁, . . . , 140ₙ, 150 being arranged adjacent the second side 114 of the first RF electrode 110 and a second set 140₁, . . . , 140ₙ of the plurality of DC electrodes 130₁, . . . , 130ₙ, 140₁, . . . , 140ₙ, 150 being arranged adjacent the second side 124 of the second RF electrode 120.

In addition to that, and as shown in FIGS. 1A and 1B, at least a further DC electrode 150 of the plurality of DC electrodes 130₁, . . . , 130ₙ, 140₁, . . . , 140ₙ, 150 may be arranged between the first side 112 of the first RF electrode 110 and the first side 122 of the second RF electrode 120. This further DC electrode 150 may be a single electrode (as exemplarily illustrated in FIG. 1A) or comprise a plurality of segments (as exemplarily illustrated in FIG. 1B).

Another example is exemplarily illustrated with respect to FIG. 1C, where the first set 130₁, . . . , 130ₙ of the plurality of DC electrodes and the second set 140₁, . . . , 140ₙ of the plurality of DC electrodes is not present. In the exemplary embodiments illustrated by FIGS. 1A and 1B, the first set 130₁, . . . , 130ₙ of the plurality of DC electrodes and the second set 140₁, . . . , 140ₙ of the plurality of DC electrodes may be used for providing a trapping potential and the at least one further DC electrode 150 may be used for one or more of shielding, straight field compensation, and enhancing the trapping potential. The device 100C, as illustrated in FIG. 1C comprises a plurality (e.g., three or more) of the at least one further DC electrode 150 that is arranged between the first side 112 of the first RF electrode 110 and the first side 122 of the second RF electrode 120. In the exemplary embodiment shown in FIG. 1C, the plurality of further DC electrodes 150 is configured to provide a trapping potential for trapping one or more ions. The exemplary device 100C shown in FIG. 1C comprises at least seven DC electrodes 150. However, the present disclosure is not limited to seven DC electrodes 150, but more or less electrodes 150 can be present. In an example, only three DC electrodes 150 could be present.

Referring back to any of FIGS. 1A-1C, substrate 160 may have an upper surface (also referred to as first major surface) on which the first RF electrode 110, the second RF electrode 120, and the plurality of DC electrodes 130₁, . . . , 130ₙ, 140₁, . . . , 140ₙ, 150 are arranged. In examples, the upper surface of substrate 160 may be substantially planar. In embodiments, the substrate 160 may comprise one or more of semiconductor material (such as Si, SiC and GaN or similar materials), fused silica, quartz glass, and sapphire. While not limited to these values, the substrate 160 may have a thickness of 400 μm to 1 mm (such as 725 μm or 750 μm for example).

The first RF electrode 110, the second RF electrode 120, and the plurality of DC electrodes 130₁, . . . , 130ₙ, 140₁, . . . , 140ₙ, 150 may be connected to signal lines (not shown in FIGS. 1A-1C) for providing respective signals to these electrodes. For example, the signal lines can be conductors arranged on the surface of substrate 160. In addition to that or as an alternative, signal lines can be routed in a further structured metal layer that is arranged between the RF and/or DC electrodes 110, 120, 130₁, . . . , 130ₙ, 140₁, . . . , 140ₙ, 150 and the substrate 160. Yet as a further alternative, signal lines may reach through the substrate 160 and connect the RF and/or DC electrodes 110, 120, 130₁, . . . , 130ₙ, 140₁, . . . , 140ₙ, 150 to a metallization structure on the opposing side of the substrate 160. The signal lines may be connected to respective signal generators (such as digital-to-analog converters in case of the

DC electrodes 130₁, . . . , 130ₙ, 140₁, . . . , 140ₙ, 150 or a resonator in case of the first and second RF electrodes 110, 120) that provide the respective signals to the electrodes. The respective signal generators may be connected via one or more intervening circuit elements, such as capacitors or other filters.

The first RF electrode 110, the second RF electrode 120, and the plurality of DC electrodes 130₁, . . . , 130ₙ, 140₁, . . . , 140ₙ, 150 are configured to create a trapping potential (such as an electromagnetic field) for trapping one or more particles (such as such as ions, molecules or electrons). For example, the plurality of DC electrodes 130₁, . . . , 130ₙ, 140₁, . . . , 140ₙ, 150 may create a potential (e.g., a static electric field) that confines the one or more particles in the first direction x, and the first RF electrode 110 and the second RF electrode 120 may create a potential (e.g., an RF electromagnetic field) that confines the one or more particles in the second direction y and in the third direction z (which is orthogonal to the first and the second directions). This may result in a potential (e.g., an electromagnetic field) that traps the one or more particles in all three directions in space.

Typically, the DC electrodes 130₁, . . . , 130ₙ, 140₁, . . . , 140ₙ, 150 are further (such as in addition to trapping) configured to move (such as shuttle) the one or more particles from a first position of the device 100A, 100B, 100C to a second position of the device 100A, 100B, 100C by having respective voltage signals being applied on the DC electrodes 130₁, . . . , 130ₙ, 140₁, . . . , 140ₙ, 150.

In practical applications, the signal being applied to the first RF electrode 110 and the second RF electrode 120 may be the same. The signal being applied to the first RF electrode 110 and the second RF electrode 120 typically comprises a constant amplitude A and a constant frequency w and can be denoted as V_{RF}=A×sin ωt.

The signals being applied to the DC electrodes 130₁, . . . , 130ₙ, 140₁, . . . , 140ₙ, 150 may vary in time depending on the application. For example, if one or more particles shall be trapped at a position of the device 100A, 100B, 100C, one or a pair of the DC electrodes 130₁, 130ₙ, 140₁, . . . , 140ₙ, 150 may provide a lower potential than the remainder of the DC electrodes.

In the center region 170, the potential that is created by the first RF electrode 110 and the second RF electrode 120 may have a contribution to the first direction x that is neglectable when being compared to the potential in the first direction x that is being created by the DC electrodes 130₁, . . . , 130ₙ, 140₁, . . . , 140ₙ, 150. In the ending region 180 of device 100A, 100B, 100C the potential that is created by the first RF electrode 110 and the second RF electrode 120 may have a contribution to the first direction x that is not neglectable when being compared to the potential in the first direction that is being created by the DC electrodes 130₁, . . . , 130ₙ, 140₁, . . . , 140ₙ, 150. In other words, the first RF electrode 110 and the second RF electrode 120 may create a potential barrier in the first direction x in the ending region 180. This may prevent the one or more particles that are trapped by device 100A, 100B, 100C from leaving the trapping device (e.g., this may slow down and stop one or more particles moving along the first direction x towards the ends 116 and 126 of the first and second RF electrodes 110 and 120.)

Referring now to FIGS. 2A-2C, where same reference signs refer to the same or similar elements as in FIGS. 1A-1C. The device 100A, 100B, 100C as illustrated in FIGS. 1A-1C can comprise a single substrate 160, as exemplarily illustrated in FIG. 2A (also sometimes referred to as 2D trapping device 200A or surface trapping device 200A). The device 200A exemplarily illustrated in FIG. 2A may be a cross-section along the second and third directions y, z (such as the y-z plane) of device 100A and 100B shown in FIG. 1A and 1B. As discussed with regard to FIG. 1C further above, some of the DC electrodes of the device 200A (such as DC electrodes 130 and 140 may be optional (not shown in FIG. 2A). Again, the devices 200A, 200B, 200C may include additional DC electrodes, e.g., for compensating straight fields (e.g., connected to a ground potential or to another compensation potential) and/or for shielding that are not illustrated in the drawings.

Examples of 3D trapping devices 200B, 200C are exemplarily illustrated in FIGS. 2B and 2C, where the trapping device 200B, 200C comprises a second substrate 162 (in addition to the first substrate 160). The second substrate 162 is arranged with a distance to the first substrate 160 along the third direction z. For example, a particle (such as an ion) may be trapped between the first substrate 160 and the second substrate 162.

In the example shown in FIG. 2B, additional DC electrodes 132 and 142 may be arranged on the second substrate 162 such that a surface of the additional DC electrodes 132 and 142 faces towards a surface of the first RF electrode 110, the second RF electrode 120, and the DC electrodes 130₁, . . . , 130ₙ, 140₁, . . . , 140ₙ, 150 that are arranged on the first substrate 160. The additional DC electrodes 132 and 142 on the second substrate 162 may be fabricated in a similar fashion as the electrodes on the first substrate 160 (e.g., by structuring one or more metal layers on the substrate). In the example shown in FIG. 2B, the part of device 200B that is arranged on the first substrate 160 can be the same or similar as the previously discussed devices 100A, 100B, 100C, 200A. In addition to that, when the additional electrodes 132 and 142 (which each can comprise a plurality of electrode segments) are present, the remaining DC electrodes 130, 140, 150 may be omitted in some examples.

In the exemplary device 200A and 200B shown in FIG. 2A and 2B, the first RF electrode 110 and the second electrode 120 are arranged on a first substrate 160 such that the first RF electrode and the second RF electrode are arranged within a common plane (which would be the x-y plane illustrated in the examples of FIGS. 2A and 2B.

Referring now to FIG. 2C, where an exemplary device 200C is shown, where the first RF electrode 110 is arranged on the first substrate 160 and the second RF electrode 120 is arranged on the second substrate 162 such that the first RF electrode 110 and the second RF electrode 120 are arranged in two separate planes. The two separate planes may be parallel with respect to each other and spaced apart from each other in the third direction z. In this example, the first set of DC electrodes 130 and the at least one further DC electrode 150 is arranged on the first substrate 160 and the second set of DC electrodes 140 is arranged on the second substrate, as can be seen in FIG. 2C. It is worth mentioning that the first side 112 of the first RF electrode 110 and the first side 122 of the second RF electrode 120 are still consider as facing each other within the context of this disclosure (despite the first and second RF electrodes 110 and 120 laying in different planes). Again, the further DC electrode 150 is optional as described further above.

The layout of a device 100A, 100B, 100C, 200A, 200B, 200C for trapping one or more particles as shown with respect to FIGS. 1A-2C can be combined in many ways, and the disclosure of the present disclosure as set forth herein shall not be limited to any specific ones of these layouts.

It is known from Felix Stopp et al (2021) arXiv:2108.06948v1 [quant-ph] that altering the amplitude A of the RF signal VRF over a given time Δt (also referred to as ramping) may allow trapped particles to leave the trapping device and to enter free space. Similarly, particles coming from free space may be captured by the trapping device in a similar manner. However, in practical applications it may be challenging to time and tune the ramping may be difficult.

According to examples of the present disclosure, the trap layout may be modified so that trapped particles may leave and enter a trapping device without having to ramp the amplitude of the RF signal.

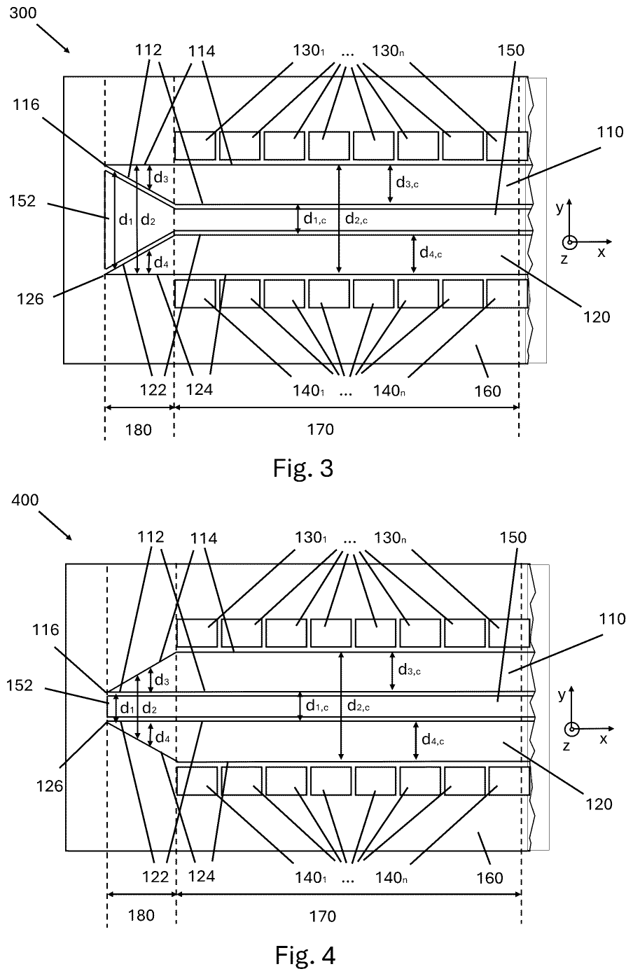

Referring now to FIGS. 3-7, illustrating exemplary devices 300, 400, 500, 600, 700 for trapping one or more particles according to the present disclosure. Same reference signs as already shown and discussed with regard to FIGS. 1A-2C shall be the same and will not be described again in detail, but reference is made to what has been described further above. Again, the devices 300, 400, 500, 600, 700 may include additional DC electrodes, e.g., for compensating straight fields (e.g., connected to a ground potential or to another compensation potential) and/or for shielding that are not illustrated in the drawings.

The exemplary devices 300, 400, 500, 600, 700 show a similar layout as device 100A shown in FIG. 1A and device 200A shown in FIG. 2A. However, as discussed further above, with regard to FIGS. 1A-2C other layouts for trapping devices are possible (e.g., where the DC electrodes are arranged in a different fashion and/or some DC electrodes being omitted; or with the first RF electrode 110 and the second RF electrode 120 laying in two different planes as shown in FIG. 2C). The trapping device according to the present disclosure shall not be limited to the specific layout shown in FIGS. 3-7 but shall encompass any of such variations.

Still referring to FIGS. 3-7, the devices 300, 400, 500, 600, 700 are similar to the devices 100A, 100B, 100C, 200A, 200B, 200C as already described above, in that they have a same or similar center region 170 with the first RF electrode 110, the second RF electrode 120 and the DC electrodes 130₁, . . . ,, 130ₙ, 140₁, . . . , 140ₙ, 150, 132, 142 being arranged in a same or similar fashion in the center region 170 In addition, in the ending region 180, the first RF electrode 110 and the second RF electrode 120 of the devices 300, 400, 500, 600, 700 (as exemplarily illustrated in FIGS. 3-7) are tapered, or spaced further away from each other (as compared to in the center region) or a combination of both. This may reduce a contribution of the potential generated by the RF electrodes 110 and 120 to the first direction x in the ending region 180, thereby allowing trapped particles to leave the trapping device more easily and/or allowing incoming particles to enter the trapping device more easily.

According to some embodiments, in addition to that, a part 152 of the at least one further DC electrode 150 that is located in the ending region 180 may follow the shape of the first RF electrode 110 and the second electrode 120 such that respective distances between the first side 112 of the first RF electrode 110 and the further DC electrode(s) 150 as well as between the first side 122 of the second RF electrode 120 and the further DC electrode(s) 150 in the edge region 180 remain substantially the same as in the center region 170. While in FIGS. 3-7 part 152 of DC electrode 150 is illustrated as part of a single DC electrode 150 extending from the center region 170 to the ending region 180, it may also possible that part 152 in the ending region 180 is a separate DC electrode or comprises multiple DC electrode segments (as for example, illustrated in FIG. 1B). In some examples, a width of part 152 is larger than the first distance d_{1,c}. The part 152 of DC electrode 150 in the ending region 180 as illustrated in FIGS. 3-7 is not necessarily required, but is an optional feature and could not be present. In that case, no DC electrode or no part of a DC electrode may be present between the first RF electrode 110 and the second RF electrode 120 in the ending region 180.

While not shown in FIGS. 3-7, in some examples, an outer side of the ending region 180 of the first RF electrode 110 and the second RF electrode 120 may be aligned with an edge of substrate 160. In other words, substrate 160 may end (e.g., in the first direction x) where ends 116 and 126 of the first RF electrode 110 and the second RF electrode are located such that ends 116 and 126 are located at an edge of substrate 160.

In embodiments, in the ending region 180 of the first RF electrode 110 and the second RF electrode 120, one or both of the following two features is fulfilled: (i) the first side 112 of the first RF electrode 110 and the first side 122 of the second RF electrode 120 have a distance d₁ that is greater than the first distance d_{1,c}; and (ii) the second side 114 of the first RF electrode 110 and the second side 124 of the second RF electrode 120 have a distance d₂ that is less than the second distance d_{2,c}. The first distance d_{1,c} and the second distance d_{2,c} are taken in the center region 170 of the first RF electrode 110 and the second RF electrode 120. As discussed above, the first distance d_{1,c} is taken between the first side 112 of the first RF electrode 110 and the first side 122 of the second RF electrode 120. The second distance d_{2,c} is taken between the second side 112 of the first RF electrode 110 and the second side 122 of the second RF electrode 120. The first distance, the second distance d_{2,c}, the distance d₁ and the distance d₂ may be measured along a same direction (such as a direction that is orthogonal to the first direction x, as explained further above).

Now referring to FIGS. 3 and 5-7, illustrating exemplary trapping devices 300, 500, 600, 700 according to the present disclosure. In the embodiments exemplarily illustrated in FIGS. 3 and 5-7, in the ending region 180 of the first RF electrode 110 and the second RF electrode 120, the distance d₁ between the first side 112 of the first RF electrode 110 and the first side 122 of the second RF electrode 120 increases towards the end 116 of the first RF electrode 110 and towards the end 126 of the second RF electrode 120 along the first direction X.

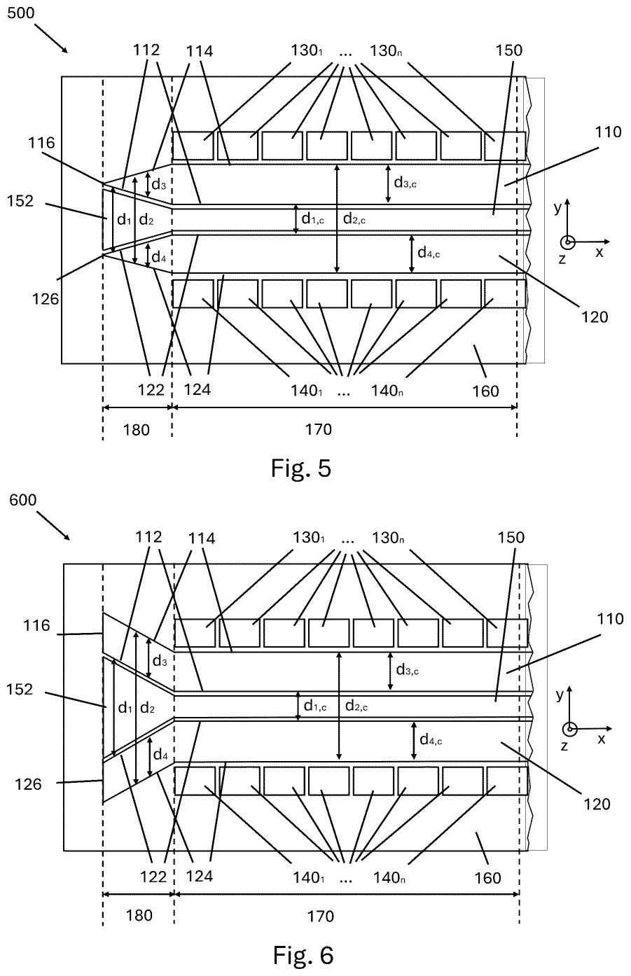

In some embodiments, as exemplarily illustrated in FIG. 5, the distance d₂ between the second side 114 of the first RF electrode 110 and the second side 124 of the second RF electrode 120 decreases towards the end 116 of the first RF electrode 110 and towards the end 126 of the second RF electrode 120.

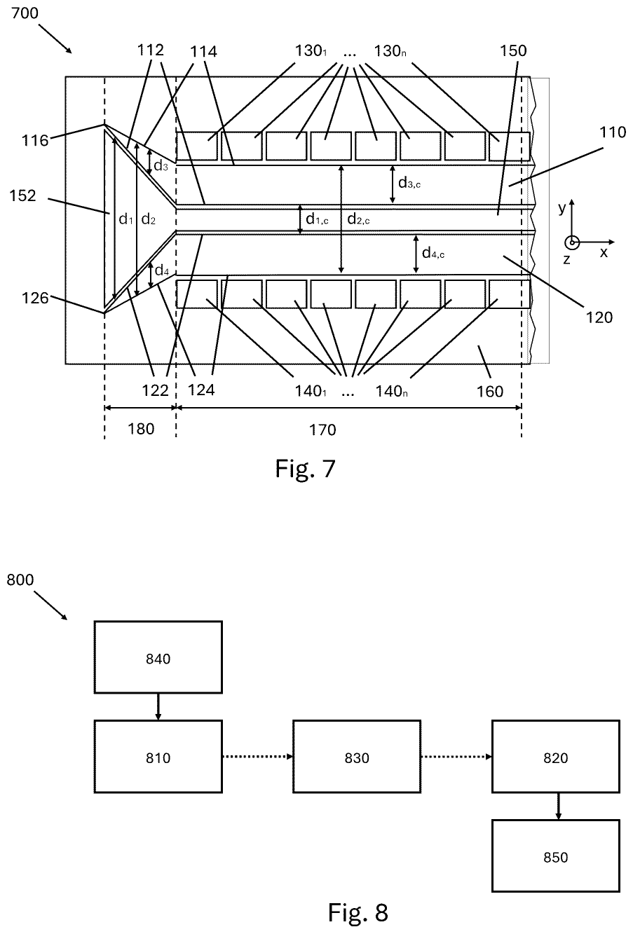

In other embodiments, as exemplarily illustrated in FIGS. 6 and 7, the distance d₂ between the second side 114 of the first RF electrode 110 and the second side 124 of the second RF electrode 120 increases towards the end 116 of the first RF electrode 110 and towards the end 126 of the second RF electrode 120.

According to further embodiments, as exemplarily illustrated in FIG. 3, the distance d₂ between the second side 114 of the first RF electrode 110 and the second side 124 of the second RF electrode 120 substantially remains constant towards the end 116 of the first RF electrode 110 and towards the end 126 of the second RF electrode 120.

Referring now to FIGS. 4 and 5, illustrating exemplary trapping devices 400 and 500 according to the present disclosure. In the embodiments exemplarily illustrated in FIGS. 4 and 5, in the ending region 180 of the first RF electrode 110 and the second RF electrode 120, the distance d₂ between the second side 114 of the first RF electrode 110 and the second side 124 of the second RF electrode 120 decreases towards an end 116 of the first RF electrode 110 and towards an end 126 of the second RF electrode 120.

In an embodiment, as exemplarily illustrated in FIG. 5, the distance d₁ between the first side 112 of the first RF electrode 110 and the first side 122 of the second RF electrode 120 increases towards the end 116 of the first RF electrode 110 and towards the end 126 of the second RF electrode 120.

In another embodiment, as exemplarily illustrated in FIG. 4, the distance d₁ between the first side 112 of the first RF electrode 110 and the first side 122 of the second RF electrode 120 substantially remains constant towards the end 116 of the first RF electrode 110 and towards the end 126 of the second RF electrode 120. In yet another embodiment, that is otherwise similar to the embodiment illustrated in FIG. 4, the distance d₁ between the first side 112 of the first RF electrode 110 and the first side 122 of the second RF electrode 120 decreases towards the end 116 of the first RF electrode 110 and towards the end 126 of the second RF electrode 120. In this embodiment, the first RF electrode 110 and the second RF electrode 120 has a tapered shape in the ending region 180 (e.g., the decrease in d₂ is greater than the decrease in d₁ in the ending region 180).

Referring now to FIGS. 3, 5, and 7 illustrating exemplary trapping devices 300, 500 and 700 according to the present disclosure. In the embodiments exemplarily illustrated in FIGS. 3, 5 and 7, in the ending region 180 of the first RF electrode 110 and the second RF electrode 120, the first side 112 of the first RF electrode 110 and the second side 114 of the first RF electrode 110 have a distance d₃ that is less than the third distance d_{3,c} (where d_{3,c} being taken in the center region 170 in accordance with what has been described further above). In addition or as an alternative, in the ending region 180 of the first RF electrode 110 and the second RF electrode 120, the first side 122 of the second RF electrode 120 and the second side 124 of the second RF electrode 120 have a distance d₄ that is less than the fourth distance (d_{4,c} being taken in the center region 170 in accordance with what has been described further above).

Referring now to FIG. 6 illustrating an exemplary trapping device 600 according to the present disclosure. In the embodiment exemplarily illustrated in FIG. 6, in the ending region 180 of the first RF electrode 110 and the second RF electrode 120, the first side 112 of the first RF electrode 110 and the second side 114 of the first RF electrode 110 have a distance d₃ that is substantially equal to the third distance d_{3,c}, and the first side 122 of the second RF electrode 120 and the second side 124 of the second RF electrode 120 have a distance d₄ that is substantially equal to the fourth distance d_{4,c} (d_{3,c} and d_{4,c} being taken in the center region 170 in accordance with what has been described further above).

Referring now to FIGS. 3-5, and 7 illustrating exemplary trapping devices 300, 400, 500 and 700 according to the present disclosure. In the embodiments exemplarily illustrated in

FIGS. 3-5 and 7, in the ending region 180 of the first RF electrode 110 and the second RF electrode 120, the first RF electrode 110 and the second RF electrode 120 each have a tapered shape.

Referring now to FIGS. 3 and 5-7 illustrating exemplary trapping devices 300, 500, 600 and 700 according to the present disclosure. In the embodiments exemplarily illustrated in FIGS. 3 and 5-7, in the ending region 180 of the first RF electrode 110 and the second RF electrode 120, the first RF electrode 110 and the second RF electrode 120 are spaced further away from each other as compared to in the center region 170.

Although the exemplary illustrated devices 300, 400, 500, 600, 700 are illustrated with a linearly changing distances d₁, d₂, d₃, and d₄ in the ending region 180, also different slopes may be possible and the present disclosure shall not be limited to linear slopes. Similarly, although the exemplarily illustrated devices 300, 400, 500 and 700 are illustrated with a sharp end 116 of the first RF electrode 110 and a sharp end 126 of the second RF electrode 120, the ends 116 and 126 do not necessarily have to be sharp so that also different shapes of ends 116 and 126 shall be encompassed by the present disclosure.

In the following exemplary applications of a trapping device 300, 400, 500, 600, 700 according to the present disclosure are set forth. For example, since an RF signal being applied to the first RF electrode 110 and the second RF electrode 120 may remain unaltered while particles are leaving or entering the trapping device (such as the amplitude may remain being constant), the trapping device 300, 400, 500, 600, 700 according to the present disclosure may allow a mode of operation, where some particles are being trapped at the center region 170 of the trapping device 300, 400, 500, 600, 700 while at the same time other particles may enter or leave at the ending region 180 of the same trapping device 300, 400, 500, 600, 700. In other words, the same pair of first RF electrode 110 and second RF electrode 120 can be used for both trapping and loading/de-loading particles in the trapping device 300, 400, 500, 600, 700. For trapping device layouts that require an RF ramp for sending particles to free space or re-capturing the particles from free space at the ending region, the RF ramp may not allow to keep another set of particles being trapped by the same device in the center region (but due to the RF ramp, the trapped particles in the center region may be lost).

For example, the device 300, 400, 500, 600, 700 for trapping one or more particles according to the present disclosure may be configured to receive one or more particles at the ending region 180 of the first RF electrode 110 and the second RF electrode 120, and trap the received one or more particles in the center region 170 of the first RF electrode 110 and the second RF electrode 120 using the plurality of DC electrodes 130₁, . . . 130ₙ, 140₁, . . . , 140ₙ, 150. In the same or in other examples, an RF signal being applied to the first RF electrode 110 and the second RF electrode 120 may remain unaltered (such as the amplitude A and the frequency w of the RF signal VRF may remain constant) during the reception of the one or more particles at the ending region 180 of the first RF electrode 110 and the second RF electrode 120. For example, at least some of the plurality DC electrodes 130₁, . . . , 130ₙ, 140₁, . . . , 140ₙ, 150, 132, 142 may be used to receive (such as capture) the one or more particles. In other examples, additional DC electrodes arranged on the first substrate 160 or second substrate 162 may be used to receive (such as capture) the one or more particles. For example, DC voltage pulses may be applied to the mentioned electrodes for capturing the particles.

In yet the same or in different examples, the device 300, 400 500, 600, 700 is configured to accelerate one or more particles from the center region 170 towards the ending region 180 such that the one or more particles leave the ending region 180. In the same or in other examples, an RF signal being applied to the first RF electrode 110 and the second RF electrode 120 may remain unaltered (such as the amplitude A and the frequency w of the RF signal VRF may remain constant) during the acceleration of the one or more particles at the ending region 180 of the first RF electrode 110 and the second RF electrode 120. For example, at least some of the plurality DC electrodes 130₁, . . . , 130ₙ, 140₁, . . . , 140ₙ, 150, 132, 142 may be used to accelerate the one or more particles. In other examples, additional electrodes arranged on the first substrate 160 or second substrate 162 may be used to accelerate the one or more particles. In addition to that or as an alternative, electrodes that are not arranged on any of the first and second substrates (not shown) may be used to accelerate the one or more particles.

Regarding the velocity of incoming particles to be trapped with the device 300, 400, 500, 600, 700 according to the present disclosure, it will be clear to the person skilled in the art, that the direction of the velocity should point towards the first direction x (into which the first RF electrode 110 and the second RF electrode 120 extend). In addition to that, it will be clear to the skilled person that the kinetic energy of the incoming particles should be higher than the remaining potential in the first direction x in the ending region 180 of the trapping device 300, 400, 500, 600, 700 and lower than the potentials in first, second and third directions in the center region 170 of the trapping device generated by the first RF electrode 110, the second RF electrode 120 and the DC electrodes 130₁, . . . , 130ₙ, 140₁, . . . , 140ₙ, 150, 132, 142 for trapping the particles. The direction and kinetic energy of the incoming particles may be controlled by appropriate measures (e.g., using one or more Sikler lenses) which are known to persons skilled in the art.

FIG. 8 illustrates yet another application for one or more of the trapping devices described in the present disclosure. FIG. 8 illustrates a system 800 including a first device 810 for trapping one or more particles (such as ions, molecules or electrons) and a second device 820 for trapping one or more particles according to an example of the present disclosure.

Generally, the first trapping device 810 and the second trapping device can be any one of the trapping devices 100A, 100B, 100C, 200A, 200B, 200C, 300, 400, 500, 600, 700 as described above with reference to FIGS. 1A-7. In some embodiments, one or both of the first trapping device 810 and the second trapping device 820 is a trapping device 300, 400, 500, 600, 700 as described above with reference to FIGS. 3-7. In other embodiments, one or both of the first device 810 and second device 820 may be a trapping device as described with regard to FIGS. 1A-1C and a ramp of the RF signal may be used to send the one or more particles from the first device 810 to the second device 820.

In some practical applications, one or more particles are loaded from a particle source 840 to a trapping device for performing one or more quantum gate operations (e.g., for quantum computing). Typically, the particle source 840 is located in close proximity or integrated to the trapping device 810. When loading ions into a trapping device 810, a typical problem that arises is that some of the particles coming from the particle source 840 may enter the center region 180 of the trapping device 810, but may not be trapped by the trapping device 810. This may cause a contamination of surfaces of at least one of the first RF electrode, the second RF electrode 110, 120 and the plurality of DC electrodes 130₁, . . . , 130ₙ, 140₁, . . . , 140ₙ, 150, 132, 142, which in turn may cause stray fields that may influence or deteriorate the trapping potential of the electrodes.

According to the present disclosure, a first trapping device 810 may be used to trap one or more particles from a particle source 840, and a separate second trapping device 820 may be used for performing one or more quantum gate operations on the one or more particles.

The first device 810 may be configured to provide the one or more trapped particles to the second device 820 for further processing. In some examples, a valve element 830 may be present between the first device 810 and the second device 820 that may only open when one or more particles are provided from the first device 810 to the second device 820.

The second device 820 may further be configured to trap the one or more particles and subsequently move the one or more particles from a first position of the second device 820 to a second position of the second device 820, where a quantum gate operation unit 850 may be present.

According to embodiments, the first device 810 and the second device 820 may be spaced away from each other by a distance that is larger than the second distance d_{2,c}. According to examples, quantum gate operation unit 850 may include applying one or more of a laser light and a microwave to the trapped one or more particles.

In one example, the particle source 840 may include an ablation target and one or more ionization lasers. In the same or in another example, the particle source 840 may include a magneto-optical trap.

The valve element 830 may include a tube and/or a valve for controlling transport of the one or more particles from the first device 810 to the second device 820.

Separating the first device 810 (which is used for receiving the particles from the particle source 840) from the second device 820 (which is used for performing the quantum gate operation) may hinder or decrease a surface contamination of the electrodes in the second device 820. For the first device 810 surface contaminations may be acceptable, for example, in case the first device 810 is used only for providing the particles to the second trap 820 and not for performing quantum gate operations. The second device 820 may be devoid of any additional particle source (except from the particles that are provided to the second device 820 from the first device 810).

FIG. 9 illustrates a method 900 for providing one or more particles (such as ions) to a device for trapping one or more particles. For example, method 900 may be used in conjunction with a system 800 as exemplarily described above with regard to FIG. 8.

The method 900 comprises trapping 910, by a first device 810, at least one particle provided by a particle source 840. The method 900 further comprises providing 920, by the first device, the at least one particle to a second device 820. The method 900 further comprises receiving 930, by the second device 820, the at least one particle. The method 900 optionally further comprises moving the at least one received particle from a first position of the second device 820 to a second position of the second device 820. The method 900 further comprises performing 950 one or more quantum gate operations on the at least one particle.

The examples described herein provide:

Example 1. A device (200A, 200B, 200C, 300, 400, 500, 600, 700) for trapping one or more particles, the device comprising: a first radio-frequency (RF) electrode (110), a second RF electrode (120), and a plurality of direct current (DC) electrodes (130₁, . . . , 130ₙ, 140₁, . . . , 140ₙ, 150, 132, 142); wherein the first RF electrode (110) and the second RF electrode (120) extend in a first direction (x), wherein the first RF electrode (110) comprises a first side (112) and a second side (114), wherein the second side (114) of the first RF electrode (110) is arranged opposite to the first side (112) of the first RF electrode (110), wherein the second RF electrode (120) comprises a first side (122) and a second side (124), wherein the second side (124) of the second RF electrodes (120) is arranged opposite the first side (122) of the second RF electrode (120), wherein the first side (112) of the first RF electrode (110) faces towards the first side (122) of the second RF electrode (120), wherein, in a center region (170) of the first RF electrode (110) and the second RF electrode (120), the first side (112) of the first RF electrode (110) and the first side (122) of the second RF electrode (120) have a first distance (d_{1,c}) with respect to each other, wherein, in the center region (170) of the first RF electrode (110) and the second RF electrode (120), the second side (112) of the first RF electrode (110) and the second side (122) of the second RF electrode (120) have a second distance (d_{2,c}) with respect to each other, and wherein, in an ending region (180) of the first RF electrode (110) and the second RF electrode (120): the first side (112) of the first RF electrode (110) and the first side (122) of the second RF electrode (120) have a distance (d₁) that is greater than the first distance (d_{1,c}); and/or the second side (114) of the first RF electrode (110) and the second side (124) of the second RF electrode (120) have a distance (d₂) that is less than the second distance (d_{2,c}).

Example 2. The device (200A, 200B, 300, 400, 500, 600, 700) of example 1, wherein the first RF electrode (110) and the second electrode (120) are arranged on a first substrate (160) such that the first RF electrode and the second RF electrode are arranged within a common plane.

Example 3. The device (200C, 300, 400, 500, 600, 700) of example 1, wherein the first RF electrode (110) is arranged on a first substrate (160) and the second RF electrode (120) is arranged on a second substrate (162) such that the first RF electrode and the second RF electrode are arranged in two separate planes.

Example 4. The device (200A, 200B, 200C, 300, 400, 500, 600, 700) of any of the preceding examples, wherein, in the center region (170) of the first RF electrode (110) and the second RF electrode (120), the first distance (d_{1,c}) between the first side (112) of the first RF electrode (110) and the first side (122) of the second RF electrode (120) is substantially constant.

Example 5. The device (200A, 200B, 200C, 300, 400, 500, 600, 700) of any of the preceding examples, wherein, in the center region (170) of the first RF electrode (110) and the second RF electrode (120), the second distance (d_{2,c}) between the second side (114) of the first RF electrode (110) and the second side (124) of the second RF electrode (120) is substantially constant.

Example 6. The device (200A, 200B, 200C, 300, 400, 500, 600, 700) of any of the preceding examples, wherein the distance (d₁), the distance (d₂), the first distance (d_{1,c}) and the second distance (d_{2,c}) are measured in a direction that is orthogonal to the first direction (x).

Example 7. The device (200A, 200B, 200C, 300, 400, 500, 600, 700) of any of the preceding examples, wherein the plurality of DC electrodes (130₁, . . . , 130ₙ, 140₁, . . . , 140ₙ, 150) is arranged adjacent to the first RF electrode (110) and the second RF electrode (120) in the center region (170) of the first RF electrode (110) and the second RF electrode (120).

Example 8. The device (200A, 200B, 200C, 300, 400, 500, 600, 700) of example 7, wherein a first set (130₁, . . . , 130ₙ) of the plurality of DC electrodes (130₁, . . . , 130ₙ, 140₁, . . . , 140ₙ, 150) is arranged adjacent the second side (114) of the first RF electrode (110), and wherein a second set (140₁, . . . , 140ₙ) of the plurality of DC electrodes (130₁, . . . , 130ₙ, 140₁, . . . , 140ₙ, 150) is arranged adjacent the second side (124) of the second RF electrode (120).

Example 9. The device (200A, 200B, 200C, 300, 400, 500, 600, 700) of example 8, wherein at least a further DC electrode (150) of the plurality of DC electrodes (130₁, 130ₙ, 140₁, . . . , 140ₙ, 150) is arranged between the first side (112) of the first RF electrode (110) and the first side (122) of the second RF electrode (120).

Example 10. The device (200A, 200B, 200C, 300, 500, 600, 700) of any of the preceding examples, wherein, in the ending region (180) of the first RF electrode (110) and the second RF electrode (120), the distance (d₁) between the first side (112) of the first RF electrode (110) and the first side (122) of the second RF electrode (120) increases towards an end (116) of the first RF electrode (110) and towards an end (126) of the second RF electrode (120).

Example 11. The device (200A, 200B, 200C, 500) of example 10, wherein the distance (d₂) between the second side (114) of the first RF electrode (110) and the second side (124) of the second RF electrode (120) decreases towards the end (116) of the first RF electrode (110) and towards the end (126) of the second RF electrode (120).

Example 12. The device (200A, 200B, 200C, 600, 700) of example 10, wherein the distance (d₂) between the second side (114) of the first RF electrode (110) and the second side (124) of the second RF electrode (120) increases towards the end (116) of the first RF electrode (110) and towards the end (126) of the second RF electrode (120).

Example 13. The device (200A, 200B, 200C, 300) of example 10, wherein the distance (d2) between the second side (114) of the first RF electrode (110) and the second side (124) of the second RF electrode (120) substantially remains constant towards the end (116) of the first RF electrode (110) and towards the end (126) of the second RF electrode (120).

Example 14. The device (200A, 200B, 200C, 400, 500) of any of examples 1 to 9, wherein, in the ending region (180) of the first RF electrode (110) and the second RF electrode (120), the distance (d₂) between the second side (114) of the first RF electrode (110) and the second side (124) of the second RF electrode (120) decreases towards an end (116) of the first RF electrode (110) and towards an end (126) of the second RF electrode (120).

Example 15. The device (200A, 200B, 200C, 500) of example 14, wherein the distance (d₁) between the first side (112) of the first RF electrode (110) and the first side (122) of the second RF electrode (120) increases towards the end (116) of the first RF electrode (110) and towards the end (126) of the second RF electrode (120).

Example 16. The device (200A, 200B, 200C, 400) of example 14, wherein the distance (d₁) between the first side (112) of the first RF electrode (110) and the first side (122) of the second RF electrode (120 substantially remains constant towards the end (116) of the first RF electrode (110) and towards the end (126) of the second RF electrode (120).

Example 17. The device (200A, 200B, 200C, 300, 500, 600, 700) of any one of the preceding examples, wherein, in the center region (170) of the first RF electrode (110) and the second RF electrode (120), the first side (112) of the first RF electrode (110) and the second side (114) of the first RF electrode (110) have a third distance (d_{3,c}) with respect to each other and the first side (122) of the second RF electrode (120) and the second side (124) of the second RF electrode have a fourth distance (d_{4,c}) with respect to each other, wherein, in the center region (170), the third distance (d_{3,c}) is substantially constant, and the fourth distance (d_{4,c}) is substantially constant.

Example 18. The device (200A, 200B, 200C, 300, 500, 700) of example 17, wherein, in the ending region (180) of the first RF electrode (110) and the second RF electrode (120), the first side (112) of the first RF electrode (110) and the second side (114) of the first RF electrode (110) have a distance (d₃) that is less than the third distance (d_{3,c}).

Example 19. The device (200A, 200B, 200C, 300, 500, 700) of example 18, wherein, in the ending region (180) of the first RF electrode (110) and the second RF electrode (120), the first side (122) of the second RF electrode (120) and the second side (124) of the second RF electrode (120) have a distance (d₄) that is less than the fourth distance (d_{4,c}).

Example 20. The device (200A, 200B, 200C, 600) of example 17, wherein, in the ending region (180) of the first RF electrode (110) and the second RF electrode (120), the first side (112) of the first RF electrode (110) and the second side (114) of the first RF electrode (110) have a distance (d₃) that is substantially equal to the third distance (d_{3,c}), and the first side (122) of the second RF electrode (120) and the second side (124) of the second RF electrode (120) have a distance (d₄) that is substantially equal to the fourth distance (d_{4,c}).

Example 21. The device (200A, 200B, 200C, 300, 400, 500, 700) of any one of examples 1 to 19, wherein, in the ending region (180) of the first RF electrode (110) and the second RF electrode (120), the first RF electrode (110) and the second RF electrode (120) each have a tapered shape.

Example 22. The device (200A, 200B, 200C, 300, 500, 500, 700) of any one of examples 1 to 19, wherein, in the ending region (180) of the first RF electrode (110) and the second RF electrode (120), the first RF electrode (110) and the second RF electrode (120) are spaced further away from each other as compared to in the center region (170)

Example 23. The device (200A, 200B, 200C, 300, 500, 600, 700) of any of the preceding examples, wherein the device is configured to: receive one or more particles at the ending region (180) of the first RF electrode (110) and the second RF electrode (120), and trap the received one or more particles in the center region (170) of the first RF electrode (110) and the second RF electrode (120) using the plurality of DC electrodes (130₁, . . . , 130ₙ, 140₁, . . . , 140ₙ, 150).

Example 24. The device (200A, 200B, 200C, 300, 500, 600, 700) of example 23, wherein during the reception of the one or more particles at the ending region (180) of the first RF electrode (110) and the second RF electrode (120), an amplitude of an RF signal being applied to the first RF electrode (110) and the second RF electrode (120) remains unaltered.

Example 25. The device (200A, 200B, 200C, 300, 500, 600, 700) of any of the preceding examples, wherein the device is configured to: accelerate one or more particles from the center region (170) towards the ending region (180) such that the one or more particles leave the ending region.

Example 26. The device (200A, 200B, 200C, 300, 500, 600, 700) of example 25, wherein at least some of the plurality DC electrodes (130₁, . . . , 130ₙ, 140₁, . . . , 140ₙ, 150) are used to accelerate the one or more particles.

Example 27. The device (200A, 200B, 200C, 300, 500, 600, 700) of example 26, wherein during the acceleration of the one or more particles at the ending region (180) of the first RF electrode (110) and the second RF electrode (120), an amplitude of an RF signal being applied to the first RF electrode (110) and the second RF electrode (120) remains unaltered.

Example 28. The device (200A, 200B, 200C, 300, 500, 600, 700) of example 1, wherein, in the ending region (180) one or more of the plurality of DC electrodes are arranged between the first side (112) of the first RF electrode (110) and the first side (122) of the second RF electrode (120), wherein a width of the one or more of the plurality of DC electrodes is larger than the first distance (d_{1,c}).

Example 29. A system (800) comprising: a first device (810; 100A, 100B, 100C, 200A, 200B, 200C, 300, 500, 600, 700) for trapping one or more particles; a second device (820; 100A, 100B, 100C, 200A, 200B, 200C, 300, 500, 600, 700) for trapping one or more particles; and wherein the first device is configured to trap (910) at least one particle provided by a particle source (840), wherein the second device (820) is configured to: receive (930) the at least one particle from the first device (810), and perform (950) one or more quantum gate operations on the at least one particle.

Example 30. A method (900) of providing one or more particles to a device (820) for trapping one or more particles, the method comprising: trapping (910), by a first device, at least one particle provided by a particle source (840), providing (920), by the first device, the at least one particle to a second device (820), receiving (930), by the second device, the at least one particle, and performing (950), by the second device, one or more quantum gate operations on the at least one particle.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

The expression “and/or” should be interpreted to cover all possible conjunctive and disjunctive combinations, unless expressly noted otherwise. For example, the expression “A and/or B” should be interpreted to mean A but not B, B but not A, or both A and B. The expression “at least one of” should be interpreted in the same manner as “and/or”, unless expressly noted otherwise. For example, the expression “at least one of A and B” should be interpreted to mean A but not B, B but not A, or both A and B.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A device for trapping one or more particles, the device comprising:
a first radio-frequency (RF) electrode;
a second RF electrode; and
a plurality of direct current electrodes,
wherein the first RF electrode and the second RF electrode extend in a first direction,
wherein the first RF electrode comprises a first side and a second side,
wherein the second side of the first RF electrode is arranged opposite to the first side of the first RF electrode,
wherein the second RF electrode comprises a first side and a second side,
wherein the second side of the second RF electrode is arranged opposite the first side of the second RF electrode,
wherein the first side of the first RF electrode faces towards the first side of the second RF electrode,
wherein in a center region of the first RF electrode and the second RF electrode, the first side of the first RF electrode and the first side of the second RF electrode have a first distance with respect to each other, and the second side of the first RF electrode and the second side of the second RF electrode have a second distance with respect to each other, and
wherein in an ending region of the first RF electrode and the second RF electrode:
the first side of the first RF electrode and the first side of the second RF electrode have a distance that is greater than the first distance; and/or
the second side of the first RF electrode and the second side of the second RF electrode have a distance that is less than the second distance.

2. The device of claim 1, wherein the first RF electrode and the second RF electrode are arranged on a first substrate such that the first RF electrode and the second RF electrode are arranged within a common plane.

3. The device of claim 1, wherein the first RF electrode is arranged on a first substrate and the second RF electrode is arranged on a second substrate such that the first RF electrode and the second RF electrode are arranged in two separate planes.

4. The device of claim 1, wherein in the center region of the first RF electrode and the second RF electrode, the first distance between the first side of the first RF electrode and the first side of the second RF electrode is substantially constant, and wherein in the center region of the first RF electrode and the second RF electrode, the second distance between the second side of the first RF electrode and the second side of the second RF electrode is substantially constant.

5. The device of claim 1, wherein each of the distances is measured in a direction that is orthogonal to the first direction.

6. The device of claim 1, wherein in the ending region of the first RF electrode and the second RF electrode, the distance between the first side of the first RF electrode and the first side of the second RF electrode increases towards an end of the first RF electrode and towards an end of the second RF electrode.

7. The device of claim 6, wherein the distance between the second side of the first RF electrode and the second side of the second RF electrode decreases towards the end of the first RF electrode and towards the end of the second RF electrode.

8. The device of claim 6, wherein the distance between the second side of the first RF electrode and the second side of the second RF electrode increases towards the end of the first RF electrode and towards the end of the second RF electrode.

9. The device of claim 6, wherein the distance between the second side of the first RF electrode and the second side of the second RF electrode substantially remains constant towards the end of the first RF electrode and towards the end of the second RF electrode.

10. The device of claim 1, wherein in the ending region of the first RF electrode and the second RF electrode, the distance between the second side of the first RF electrode and the second side of the second RF electrode decreases towards an end of the first RF electrode and towards an end of the second RF electrode.

11. The device of claim 10, wherein the distance between the first side of the first RF electrode and the first side of the second RF electrode increases towards the end of the first RF electrode and towards the end of the second RF electrode.

12. The device of claim 10, wherein the distance between the first side of the first RF electrode and the first side of the second RF electrode substantially remains constant towards the end of the first RF electrode and towards the end of the second RF electrode.

13. The device of claim 1, wherein in the center region of the first RF electrode and the second RF electrode, the first side of the first RF electrode and the second side of the first RF electrode have a third distance with respect to each other and the first side of the second RF electrode and the second side of the second RF electrode have a fourth distance with respect to each other, and wherein in the center region, the third distance is substantially constant and the fourth distance is substantially constant.

14. The device of claim 13, wherein in the ending region of the first RF electrode and the second RF electrode, the first side of the first RF electrode and the second side of the first RF electrode have a distance that is less than the third distance.

15. The device of claim 14, wherein in the ending region of the first RF electrode and the second RF electrode, the first side of the second RF electrode and the second side of the second RF electrode have a distance that is less than the fourth distance.

16. The device of claim 15, wherein in the ending region of the first RF electrode and the second RF electrode, the first side of the first RF electrode and the second side of the first RF electrode have a distance that is substantially equal to the third distance and the first side of the second RF electrode and the second side of the second RF electrode have a distance that is substantially equal to the fourth distance.

17. The device of claim 1, wherein in the ending region of the first RF electrode and the second RF electrode, the first RF electrode and the second RF electrode each have a tapered shape.

18. The device of claim 1, wherein in the ending region of the first RF electrode and the second RF electrode, the first RF electrode and the second RF electrode are spaced further away from each other as compared to in the center region.

19. The device of claim 1, wherein the device is configured to:
receive one or more particles at the ending region of the first RF electrode and the second RF electrode; and
trap the received one or more particles in the center region of the first RF electrode and the second RF electrode using the plurality of DC electrodes.

20. The device of claim 19, wherein during the reception of the one or more particles at the ending region of the first RF electrode and the second RF electrode, an amplitude of an RF signal being applied to the first RF electrode and the second RF electrode remains unaltered.

21. The device of claim 1, wherein the device is configured to:
accelerate one or more particles from the center region towards the ending region such that the one or more particles leave the ending region.

22. The device of claim 21, wherein at least some of the plurality DC electrodes are used to accelerate the one or more particles.

23. The device of claim 22, wherein during the acceleration of the one or more particles at the ending region of the first RF electrode and the second RF electrode, an amplitude of an RF signal being applied to the first RF electrode and the second RF electrode remains unaltered.

24. The device of claim 1, wherein in the ending region, one or more of the plurality of DC electrodes is arranged between the first side of the first RF electrode and the first side of the second RF electrode, and wherein a width of the one or more of the plurality of DC electrodes is larger than the first distance.

25. A system, comprising:
a first device configured to trap one or more particles; and
a second device configured to trap one or more particles,
wherein the first device is configured to trap at least one particle provided by a particle source,
wherein the second device is configured to:
receive the at least one particle from the first device; and
perform one or more quantum gate operations on the at least one particle.

26. A method of providing one or more particles to a device for trapping one or more particles, the method comprising:
trapping, by a first device, at least one particle provided by a particle source;
providing, by the first device, the at least one particle to a second device;
receiving, by the second device, the at least one particle; and
performing, by the second device, one or more quantum gate operations on the at least one particle.
